(19) United States
(12) Patent Application Publication
(10) Pub. No.: US 2026/0055331 A1
(43) Pub. Date: Feb. 26, 2026

(54) PROCESS FOR HYDROPROCESSING A BIORENEWABLE FEEDSTOCK WITH IMPROVED JET FUEL YIELD

(71) Applicant: UOP LLC, Des Plaines, IL (US)

(72) Inventors: Neeraj Tiwari, Gurgaon (IN); Donald Eizenga, Elk Grove Village, IL (US); Prakhar Agrawal, Gurgaon (IN); Rafael Alcala, Glen Ellyn, IL (US)

(21) Appl. No.: 18/810,260

(22) Filed: Aug. 20, 2024

(51) Int. Cl. C10L 1/08; C10G 25/00; C10G 69/02

(52) U.S. Cl. CPC C10L 1/08; C10G 25/00; C10G 69/02; C10L 2270/04

(57) ABSTRACT

A process for producing biofuel from biorenewable feedstock is disclosed. The process comprises hydrotreating a biorenewable feed stream in a hydrotreating reactor to produce a hydrotreated stream. The hydrotreated stream is separated in a hot separator into a hot separated vapor stream and a hot separated liquid stream. A hydroisomerization feed stream is taken from the hot separated liquid stream and hydroisomerized in a hydroisomerization reactor in the presence of hydrogen over a hydroisomerization catalyst to provide a hydroisomerized stream. The hydroisomerized stream is contacted with a recycle vapor stream taken from the hot separated vapor stream to provide a contacted hydroisomerized stream. The contacted hydroisomerized stream may be fractionated to produce a fuel stream.

### FIELD

The field is related to a process for producing biofuel from biorenewable feedstock. The field may particularly relate to a process for producing jet fuel from biorenewable feedstock.

### BACKGROUND

As the demand for fuel increases worldwide, there is increasing interest in producing fuels and blending components from sources other than crude oil. Often referred to as biorenewable sources, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated or mono, di or poly-unsaturated.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating to deoxygenate, including decarboxylate and decarbonylate, the oxygenated hydrocarbons. Hydrotreating may be followed by hydroisomerization to improve cold flow properties of product diesel and jet fuel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst.

When producing jet fuel from triglycerides (also referred to as “fats”) a certain degree of hydrocracking and hydroisomerization is needed to meet the specifications of jet fuel as outlined in ASTM D7566 Annex 2 and ASTM D1655. These key specifications that are required of the jet fuel in D7566 are freeze point of no higher than −40° C. (ASTM D5972, D7153 or D7154), density of no more than 772 kg/m³ (ASTM D1298 or D4052), T10 of less than 205° C. (ASTM D86), and a final boiling point (FBP) of less than 300° C. (ASTM D86). Larger molecules that do not meet these jet fuel specifications are hydrocracked primarily to meet these specifications which inherently results in low yield in the production process and in a low energy

Molecules in jet fuel usually range from hydrocarbons containing 8 carbon atoms (C8) to those containing 16 carbon atoms (C16). A high concentration of heavier molecules such as C16 hydrocarbons can affect the freeze point of jet fuel. Sometimes, refiners resort to operating the hydroisomerization reactor at a higher severity to meet the jet fuel freeze point of about −47° C. (−52.6° F.). High severity of the hydroisomerization reactor may result in a jet fuel yield loss of about 1 w % to about 1.5 wt %.

As refiners seek to add capability for processing biorenewable feedstocks, processes are sought to produce greater volumes of jet fuel due to its high value and demand. Processes for producing diesel and increased yield of jet fuel from biorenewable feedstocks are desired.

### BRIEF SUMMARY

The present disclosure comprises a process for producing biofuel from biorenewable feedstock. The process comprises hydrotreating a biorenewable feed stream in a hydrotreating reactor to produce a hydrotreated stream. The hydrotreated stream is separated in a hot separator into a hot separated vapor stream and a hot separated liquid stream. A hydroisomerization feed stream is taken from the hot separated liquid stream and hydroisomerized in a hydroisomerization reactor in the presence of hydrogen over a hydroisomerization catalyst to provide a hydroisomerized stream. The hydroisomerized stream is contacted with a recycle vapor stream taken from the hot separated vapor stream to provide a contacted hydroisomerized stream. The contacted hydroisomerized stream may be fractionated to produce a fuel stream. The disclosed process reduces the C16 carryover resulting in the fuel yield improvement.

### BRIEF DESCRIPTION OF THE DRAWINGS

FIG. 1 is a simplified process flow diagram of the process for producing biofuel from biorenewable feedstock in accordance with an exemplary embodiment of the present disclosure.

FIG. 2 is a simplified process flow diagram of the process for producing biofuel from biorenewable feedstock in accordance with another exemplary embodiment of the present disclosure.

FIG. 3 is a simplified process flow diagram of the process for producing biofuel from biorenewable feedstock in accordance with yet another exemplary embodiment of the present disclosure.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take a main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “final boiling point” (FBP) means the temperature at which the sample has all boiled off using ASTM D2887, ASTM D-86 or TBP, as the case may be.

As used herein, the term “end point” (EP) means the temperature at which the sample has all boiled off using ASTM D2887, ASTM D-86 or TBP, as the case may be.

As used herein, the term “jet fuel range material” means hydrocarbons boiling in the range of an IBP between about 85° C. (185° F.) and about 135° C. (275° F.) or a T5 between about 110° C. (230° F.) and about 160° C. (320° F.) and the “recycle cut point” comprising a T95 between about 295° C. (563° F.) and about 315° C. (599° F.) using the TBP distillation method. Hydrocarbons beyond the “recycle cut point” and up to the “diesel cut point” comprising a T95 between about 343° C. (650° F.) and about 399° C. (750° F.) are the “diesel boiling range” material using the TBP distillation method.

As used herein, the term “conversion” means the ratio of product that boils below a recycle cut point to the feed that boils at or above the recycle cut point.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” is to be understood to refer to molecules having the number of carbon atoms represented by the subscript “x”. Similarly, the term “Cₓ−” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

### DETAILED DESCRIPTION

With growing emphasis on environmental and sustainable economy, it has become more and more attractive for refiners to produce green fuels as part of their portfolio to maximize their profitability from Renewable Identification Numbers (RINs) credited under the Renewable Fuel Standard Program. RINs are credits used for compliance which can be traded within the program to increase profitability. The present disclosure enables refiners to produce a jet fuel which meets the jet fuel specification without compromising the jet fuel yield of the process.

Freeze point is one of the parameters to assess the safe operability of the sustainable aviation fuel (SAF) at lower temperature. SAF that meets the freeze point specification is desirable. So, producing SAF that meets the freeze point specification is important for its operability. Applicants observed that nC16 in the SAF affects the fuel freeze point. Other normal paraffin such as nC15, and nC17 can also affect the fuel freeze point. In case of lighter feed, nC16 concentration can be so high that even operating the hydroisomerization reactor at higher severity alone does not yield SAF that meets freeze point. A process is disclosed that provides a solution that reduces nC16 concentration and other normal paraffin such as nC15, and nC17 to minimum level and down to zero, so that yield is maintained or improved while meeting SAF freeze point requirements.

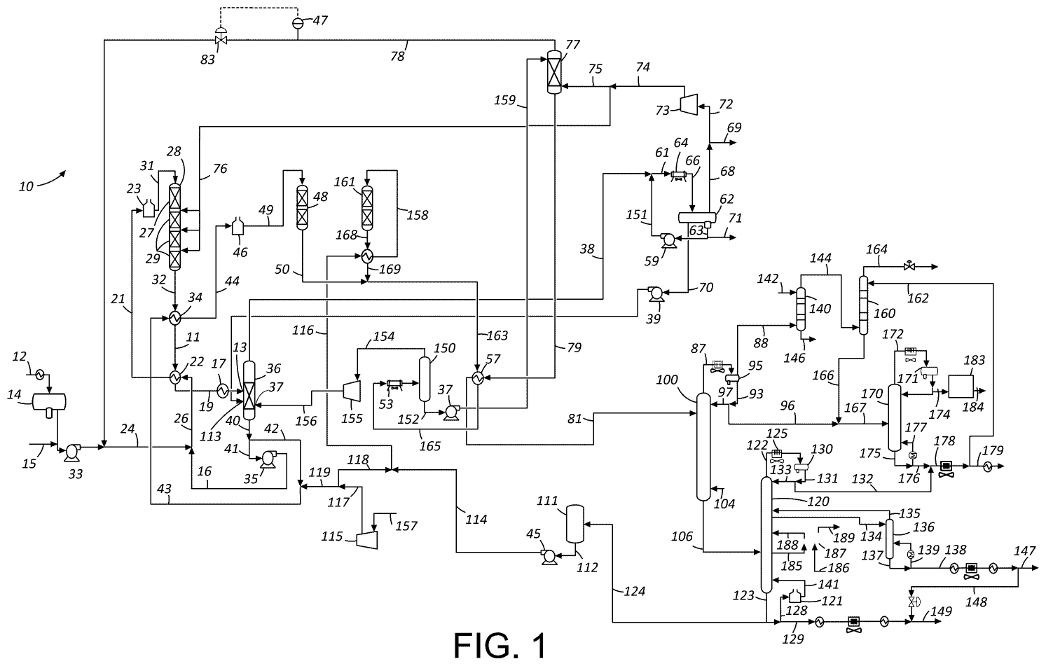

In FIG. 1, in accordance with an exemplary embodiment, a process 10 is shown for processing a hydrocarbon feedstock. Preferably, the hydrocarbon feedstock is a biorenewable hydrocarbon feedstock. A feed line 12 transports a hydrocarbon stream of fresh biorenewable feedstock into a feed surge drum 14. The biorenewable feedstock may be blended with a mineral feed stream but preferably comprises a predominance of or all biorenewable feedstock. A mineral feed stream is a conventional feed derived from crude oil that is extracted from the ground. The biorenewable feedstock may comprise a nitrogen concentration of about 50 wppm to about 2000 wppm. The biorenewable feedstock may comprise high oxygen content which can be up to 10 wt % or higher.

A variety of different biorenewable feedstocks may be suitable for the process 10. The term “biorenewable feedstock” is meant to include feedstocks other than those obtained from crude oil. The biorenewable feedstock may include any of those feedstocks which comprise at least one of glycerides and free fatty acids. Most of glycerides will be triglycerides, but monoglycerides and diglycerides may be present and processed as well. Free fatty acids may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, babassu oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Honge), Calophyllum inophyllum, Moringa oleifera and Azadirachta indica (Neem). The triglycerides and FFAs of the typical vegetable or animal fat contain aliphatic hydrocarbon chains in their structure which have about 8 to about 30 carbon atoms. Biorenewable feedstocks may also include biomass pyrolysis oils and Fischer-Tropsch waxes. As will be appreciated, the biorenewable feedstock may comprise a mixture of one or more of the foregoing examples. The biorenewable feedstock may be pretreated to remove contaminants and filtered to remove solids.

The hydrocarbon stream in feed line 12 flows from the feed surge drum 14 via a charge pump perhaps after injection with a sulfiding agent in line 15 and mixes with a recycle hydrotreating hydrogen stream in a hydrotreating hydrogen line 78 to provide a combined hydrocarbon stream in line 24. The combined hydrocarbon stream in line 24 is mixed with a hydrotreating recycle stream in a recycle line 16 to provide a hydrotreating charge hydrocarbon stream in a hydrotreating charge line 26. The recycle to feed rate can be about 1:1 to about 5:1. The hydrotreating charge hydrocarbon stream in line 26 may be preheated in a combined feed exchanger 22 by heat exchange with a hydrotreated stream in a hydrotreated line 11 and perhaps then in a fired heater 23. The heated hydrotreating charge hydrocarbon stream in the hydrotreating charge line 31 may be then charged to a hydrotreating reactor 28.

The hydrotreating reactor 28 may include a guard bed reactor or a guard bed 27. In FIG. 1, the hydrotreating reactor 28 includes a guard bed 27. The guard bed reaction temperature may range between about 246° C. (475° F.) and about 343° C. (650° F.) and suitably between about 288° C. (550° F.) and about 304° C. (580° F.). Reaction temperature is operated low enough to prevent olefins in the FFA from polymerizing but high enough to foster olefin saturation, hydrodemetallation, hydrodeoxygenation, and hydrodenitrification reactions to occur. Hydrodeoxygenation reactions preferably minimize hydrodecarbonylation and hydrodecarboxylation reactions to preserve carbon atoms on the paraffin chain.

The guard bed 27 may comprise a base metal catalyst on a support. Base metals useable in this process include non-noble metals, nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The hydrotreating charge stream can be charged through the base metal catalysts at pressures from 1379 kPa (abs) (200 psia) to 13790 kPa (abs) (2000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed 27. Although only one guard bed is shown in FIG. 1, multiple guard beds may be contained in the hydrotreating reactor 28 such as 2, 3 or more and a hydrogen quench from a hydrogen manifold 18 may be injected at interbed locations to control temperature exotherms.

A contacted hydrocarbon stream is discharged from the guard bed 27. In the guard bed 27, most of the hydrodemetallation and hydrodeoxygenation reactions will occur with some hydrodenitrogenation and hydrodesulfurization occurring. Metals removed from biorenewable feedstocks will include alkali metals and alkali earth metals and phosphorous. If the guard bed has a dedicated reactor vessel, the contacted hydrocarbon stream will discharge from the guard bed reactor. However, in FIG. 1, the guard bed 27 is contained in the hydrotreating reactor 28, so the contacted stream will receive a hydrogen quench from hydrogen manifold 76 and enter into a hydrotreating catalyst bed 29.

The biorenewable feed stream is hydrotreated in the hydrotreating reactor 28 to produce a hydrotreated effluent stream. In the hydrotreating reactor 28, the contacted hydrocarbon stream is contacted with a hydrotreating catalyst in the hydrotreating catalyst bed 29 in the presence of hydrogen at hydrotreating conditions to saturate the olefinic or unsaturated portions of the n-paraffinic chains in the biorenewable feedstock. The hydrotreating catalyst also catalyzes hydrodeoxygenation reactions, while minimizing hydrodecarboxylation and hydrodecarbonylation reactions, to remove oxygenate functional groups from the hydrocarbon molecules in the biorenewable feedstock which are converted to water and carbon oxides. The hydrotreating catalyst also catalyzes hydrodenitrogenation of organic nitrogen in the biorenewable feedstock. Essentially, the hydrotreating reaction removes heteroatoms from the hydrocarbons and saturates olefins in the feed stream.

The hydrotreating catalyst may be provided in one, two or more beds and employ interbed hydrogen quench streams from the hydrogen quench stream. Recycle hydrogen quench streams taken from the recycle hydrogen line 74 in a hydrogen manifold line 76 may be provided for interbed quench to the hydrotreating reactor 28. Three hydrotreating catalyst beds 29 are shown in FIG. 1, but more or less than three catalyst beds may be contemplated.

The hydrotreating catalyst may comprise nickel, nickel/molybdenum, or cobalt/molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200 or BDO 300 or BDO 400 available from UOP LLC in Des Plaines, Illinois. The hydrotreating reaction temperature may range from between about 271° C. (520° F.) and about 427° C. (800° F.) and preferably between about 304° C. (580° F.) and about 400° C. (752° F.). Generally, hydrotreating conditions include a pressure of about 700 kPa (100 psig) to about 21 MPa (3000 psig).

A hydrotreated effluent stream is produced in a hydrotreated line 32 from the hydrotreating reactor 28 comprising a hydrocarbon fraction which has a substantial n-paraffin concentration. Oxygenate concentration in the hydrocarbon fraction is essentially nil, whereas the olefin concentration is substantially reduced relative to the contacted biorenewable feed stream. The organic nitrogen concentration in the hydrocarbon fraction may be less than 10 wppm. The hydrotreated stream will have a concentration of nC16 paraffins of about 5 to about 50 wt %.

The hydrotreated effluent stream in the hydrotreated line 32 may first flow to the combined hydroisomerization feed exchanger 34 to heat the hydroisomerization feed stream in the hydroisomerization feed line 43 and cool the hydrotreated effluent stream in line 32. As previously described, the cooled hydrotreated effluent stream in the hydrotreated line 11 may then be further heat exchanged with the hydrotreating charge hydrocarbon stream in line 26 in the combined feed heat exchanger 22 to further cool the cooled hydrotreated effluent stream in the hydrotreated line 11 and heat the hydrotreating charge hydrocarbon stream in line 26. The twice cooled hydrotreated effluent steam in the hydrotreated line 19 may be even further cooled in another heat exchanger 17, perhaps to make steam, before it is separated.

The hydrotreated stream in line 19 may be separated to provide a hydrotreated vapor stream and a hydrotreated liquid stream having a smaller oxygen concentration than the biorenewable feed stream.

A desired product, such as a transportation fuel, may be recovered or separated from the hydrotreated stream in line 19. The hydrotreated stream in line 19 comprises a liquid portion and a gaseous portion. The liquid portion comprises a hydrocarbon fraction which is essentially all n-paraffins and has a cetane number of about 100. Although this hydrocarbon fraction is useful as a diesel fuel, because it comprises essentially all n-paraffins, it will have poor cold flow properties. If it is desired to improve the cold flow properties of the liquid hydrocarbon fraction, then the hydrotreated effluent stream in line 19 can be contacted with an hydroisomerization catalyst under hydroisomerization conditions to at least partially hydroisomerize the n-paraffins to isoparaffins, as hereinafter described.

Before hydroisomerization, the two-phase hydrotreated effluent stream in line 19 may be passed to a downstream hot separator 36 to separate the cooled hydrotreated stream into a hot separated vapor stream in line 38 and a hot separated liquid stream in line 40. In an embodiment, the hot separator may be an enhanced hot separator (EHS) 36. The hydrotreated effluent stream is separated in the hot separator 36 into a hot separated vapor stream in line 38 and a hot separated liquid stream in line 40. The hydrotreated stream in line 19 may be passed to the EHS 36 through a first inlet 13 of the EHS. The EHS 36 may be a high-pressure stripping column. The function of the EHS is to strip a certain amount of light material out of the liquid phase reactor effluent stream. The EHS typically combines gross separation of recycle vapor from liquid within a packed or trayed stripping column that achieves additional vapor stripping. The liquid phase flows down through the column where it is partially stripped of CO, CO2, H2S and H2O, which are potential hydroisomerization catalyst poisons. A stripping gas such as hydrogen in line 39 is passed to the EHS 36.

The cooled hydrotreated stream may be separated in the EHS 36 with the aid of a stripping gas such as hydrogen fed in the stripping line 156. The hydrotreated stream in line 19 is separated to provide a hot separated vapor stream in a hot separated vapor stream in line 38 and a hot separated liquid stream in a hydrotreated bottoms line 40 having a smaller oxygen concentration than the hydrotreating charge hydrocarbon stream in line 26. In the EHS 36, the hydrotreated effluent stream from the hydrotreated line 32 flows down through the column where it is partially stripped of hydrogen, carbon dioxide, carbon monoxide, water vapor, propane, hydrogen sulfide, and phosphine, which are potential hydroisomerization catalyst poisons, by contact with stripping gas from the stripping line 156.

The stripping gas in the stripping line 156 enters the hydrotreating separator 36 at an inlet 37 below the inlet 13 for the hydrotreated effluent stream in the hydrotreated line 19. The hydrotreating separator 36 may include internals such as trays or packing located between the inlet 13 for the hydrotreated effluent stream in line 19 and the inlet 37 for the stripping gas in the stripping line 39 to facilitate stripping of the hydrotreated stream.

The hydrotreating separator 36 operates at about 177° C. (350° F.) to about 371° C. (700° F.) and preferably operates at about 232° C. (450° F.) to about 315° C. (600° F.). The hydrotreating separator 36 may be operated at a slightly lower pressure than the hydrotreating reactor 28 accounting for pressure drop through intervening equipment. The hydrotreating separator 36 may be operated at pressures between about 3.4 MPa (gauge) (493 psig) and about 20.4 MPa (gauge) (2959 psig). The hot separated vapor stream in the hydrotreating separator overhead line 38 may have a temperature of the operating temperature of the hydrotreating separator 36.

The hydrotreated liquid stream which may have been stripped collects in the bottom of the hydrotreating separator 36 and flows in a hot separated liquid stream in a hydrotreated bottoms line 40. The liquid hydrotreated stream comprises diesel range material, with a high paraffinic concentration if the hydrocarbon feed comprises a biorenewable feedstock. The liquid hydrotreated stream in the hydrotreating separator bottoms line 40 may be split into two streams: a hydroisomerization feed stream taken in a hydroisomerization charge line 42 and the recycle hydrotreated stream taken in the recycle line 41 both taken from the liquid hydrotreated stream in the hydrotreated bottoms line 40. The recycle hydrotreated stream in the recycle line 41 may be pumped and a pumped recycle hydrotreated stream in line 16 may be combined with the combined hydrocarbon stream in line 24 as previously described.

While a desired product, such as a transportation fuel, may be provided in the hydrotreated bottoms line 40 because the liquid hydrotreated stream comprises a higher concentration of normal paraffins, it will possess poor cold flow properties and high FBP disqualifying it from meeting jet fuel specifications. Accordingly, to improve the cold flow properties and reduce FBP, the hydrotreated liquid stream may be hydroisomerized. A hydroisomerization feed stream may be taken from the hot separated liquid stream in line 40 and hydroisomerized in an hydroisomerization reactor in the presence of hydrogen over a hydroisomerization catalyst to provide a hydroisomerized stream

Make-up hydrogen gas in make-up line 157 may be compressed in a make-up gas compressor 115 to provide compressed make up gas in a compressed make-up gas header 117. A hydroisomerization make-up gas stream in line 119 is taken from the make-up gas header 117 and mixed with the hydroisomerization feed stream in line 42 taken from the hot separated liquid stream in line 40 to provide a combined hydroisomerization charge stream in the combined hydroisomerization charge line 43. Optionally, a portion of the compressed make-up gas stream may be passed to the hydrotreating separator 36 in the stripping gas line 156. In an aspect, greater than 99 wt-% of nC16 hydrocarbons in the hydrotreated effluent stream in line 32 is hydroisomerized in the hydroisomerization reactor 48.

The combined hydroisomerization charge stream in the combined hydroisomerization charge line 43 may be heated in an hydroisomerization feed exchanger 34 by heat exchange with the hydrotreated effluent stream in the hydrotreated line 32. A heated combined hydroisomerization charge stream in line 44 may be further heated in a hydroisomerization charge heater 46 to bring the combined hydroisomerization charge stream to hydroisomerization temperature before charging the combined hydroisomerization charge stream in a heated hydroisomerization charge line 49 to the hydroisomerization reactor 48.

Hydroisomerization, including hydrodewaxing, of the normal hydrocarbons in the hydroisomerization reactor 48 can be accomplished over one or more beds of hydroisomerization catalyst, and the hydroisomerization reaction may be operated in a co-current mode of operation. Fixed bed, trickle bed down-flow or fixed bed liquid filled up-flow modes are both suitable.

The hydroisomerization catalyst comprises a dehydrogenation metal, a molecular sieve and a metal oxide binder. The hydroisomerization catalyst may comprise a dehydrogenation metal comprising a Group VIII metal. The dehydrogenation metal(s) may be selected from platinum, palladium, nickel, nickel molybdenum sulfide or nickel tungsten sulfide. Preferably, the dehydrogenation metal is selected from platinum or nickel tungsten sulfide. The concentration of dehydrogenation metal on the hydroisomerization catalyst may comprise from 0.05 to 5 wt % based on the transition metal(s).

The dehydrogenation metal is distributed between the molecular sieve and the binder with about 40 to about 65 wt %, preferably 45 to about 60 wt %, of the metals distributed on the molecular sieve and about 40 to about 65 wt %, preferably 45 to about 60 wt %, of the metals distributed on the binder. The associated benefit of the hydroisomerization catalyst is high activity and selectivity toward hydroisomerization. In a further embodiment the hydroisomerization catalyst further comprises less than about 0.5 wt % carbon with the associated benefit of high activity and selectivity towards hydroisomerization.

In an embodiment, the hydroisomerization catalyst comprises one or more molecular sieves having a topology selected from AEI, AEL, AFO, AFX, ATO, BEA, CHA, FAU, FER, MEL, MFI, MOR, MRE, MTT, MWW or TON, such as EU-2, ZSM-11, ZSM-22, ZSM-23, ZSM-48, SAPO-5, SAPO-11, SAPO-31, SAPO-34, SAPO-41, SSZ-13, SSZ-16, SSZ-39, MCM-22, zeolite Y, ferrierite, mordenite, ZSM-5 or zeolite beta, with the associated benefit of the molecular sieve being active in the hydroisomerization of linear hydrocarbons.

The metal oxide binder may be taken from the group comprising alumina, silica, silica-alumina and titania or mixtures thereof. Preferably the metal oxide binder is alumina and preferably it is gamma alumina.

The hydroisomerization catalyst may comprise a molecular sieve having an AEL topology and more specifically it may be SAPO-11. Most of the acid sites on SAPO-11 are weak to moderate acid sites. More specifically, at least 50% of the total acidity on the SAPO-11 is weak acidity and at least 60-80% of the external acidity on SAPO-11 is weak acidity.

The hydroisomerization catalyst typically comprises particles having a diameter of about 1 to about 5 millimeters. The catalyst production typically involves the formation of a stable, porous support, followed by impregnation of active metals. The stable, porous support typically comprises a metal oxide as well as a molecular sieve, which may be a zeolite. The stable support is produced with a high porosity, to ensure maximum surface area, and it is typically desired to disperse the active metal over the full internal and external surface area of the support. DI-200 available from UOP LLC in Des Plaines, Illinois may be a suitable hydroisomerization catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 388° C. (730° F.), a pressure of about 3102 kPa (abs) (450 psia) to about 13790 kPa (abs) (2000 psia), a LHSV of about 0.5 to 3 hr⁻¹ and a hydrogen rate of about 337 Nm³/m³ (2,000 scf/bbl) to about 2,527 Nm³/m³ oil (15,000 scf/bbl).

A hydroisomerized stream in a hydroisomerized line 50 from the hydroisomerization reactor 48 is a branched-paraffin-rich stream. Preferably the hydroisomerized stream is predominantly a branched paraffin stream. It is envisioned that the hydroisomerized effluent may contain 80, 90 or 95 mass-% branched paraffins of the total paraffin content. Hydroisomerization conditions in the hydroisomerization reactor 48 are selected to avoid undesirable cracking, so the predominant product in the hydroisomerized stream in the hydroisomerized line 50 is a branched paraffin. By avoiding undesirable cracking, the hydroisomerized stream in the hydroisomerized line 50 will have near and only slightly less of the same composition with regard to carbon number per molecule as the hydroisomerization feed stream in the hydroisomerization charge line 42. The optimal amount of remaining normal paraffins in line 50 is dependent on the selectivity of the hydroisomerization catalysts but might typically be between 1-7 wt-% or may be less than 1 wt %. The hydroisomerized stream in the hydroisomerized line 50 may be passed to the cold separator and processed as described hereinafter in detail.

The renewable jet fuel production may exhibit relatively high carryover of nC16 hydrocarbons in the hot separated vapor stream in line 38. The carryover of nC16 hydrocarbons results in these hydrocarbons bypassing the hydroisomerization reactor 48. The bypassing of nC16 hydrocarbons in turn affects the final jet fuel freeze point because these hydrocarbons will avoid further branching that results from hydroisomerization and will consequently possess poor cold flow properties. Thus, the carryover of the nC16 hydrocarbons in the hot separated vapor stream in line 38 will produce a jet fuel that does not meet the freeze point specification. Also, in case of lighter feed stocks, a higher carryover of nC16 was observed resulting in higher SAF freeze point.

To reduce or limit the nC16 hydrocarbon carryover, the disclosed process comprises separate processing or separation steps for the hot separated vapor stream in line 38 and the hydroisomerized stream in line 50. The hot separated vapor stream in line 38 is passed to a cold separator to separate a cold vapor stream from a cold liquid stream. The separated cold vapor stream is passed to an absorber to be contacted with the hydroisomerized stream. The hydroisomerized stream absorbs the heavier components including the nC16 hydrocarbon in the separated cold vapor stream upon contact. A contacted hydroisomerized stream with reduced nC16 hydrocarbon is fractionated to produce a jet fuel that meets the freeze point specification. The present process eliminates the nC16 hydrocarbon carryover to jet fuel and provides an additional jet fuel yield of about 0.7 to about 1 wt %.

In an embodiment, the hydroisomerized stream in line 50 may be separated in a separator 150 before passing it to the cold separator 62. In an exemplary embodiment, the hydroisomerized stream in line 50 may be combined with a cracked effluent stream in line 169 to provide a combined effluent stream in line 163 and passed to the separator 150. The combined effluent stream in line 163 may be cooled by heat exchange with an absorber bottoms stream in line 79 in a heat exchanger 57 to provide a cooled combined effluent stream in line 165 and a cooled absorber bottoms stream in line 81. The cooled combined effluent stream in line 165 is passed to the separator 150 perhaps through a condenser air cooler 53. In the separator 150, the heated combined effluent stream is separated to provide a hydroisomerized vapor stream in line 154 and a hydroisomerized liquid stream in line 152. The hydroisomerized vapor stream in line 154 is taken from the overhead of the separator 150 and compressed in a recycle gas compressor 155 to provide a compressed recycle vapor stream in line 156. The compressed recycle vapor stream in line 156 may be passed as the stripping gas to the EHS 36.

The hot separated vapor stream in line 38 from the EHS 36 is separated in the cold separator 62. In an embodiment, the hot separated vapor stream in line 38 may be mixed with a wash water stream in line 151 to provide a mixed separated stream in line 61 before it is separated in the cold separator 62. The mixed separated stream in line 61 is passed to the cold separator 62. The hot separated vapor stream in line 38 may be cooled before being separated into vapor and liquid portions in the cold separator 62. In an aspect, the mixed separated stream in line 61 is passed through a condenser air cooler 64 to cool and condense at least a portion of the hot separated vapor stream in line 38. A condensed mixed stream in line 66 is taken from the condenser air cooler 64 and passed to the cold separator 62.

A water stream is also separated from a boot of the cold separator in line 63. The water stream in line 63 may be separated into the first wash water stream in line 151 and a sour water stream in line 71. The first wash water stream in line 151 is passed to a pump 59 and recycled to the cold separator 62. In the cold separator 62, vaporous components will separate and ascend to provide a cold separated vapor stream in a cold overhead line 68 and a cold separated liquid stream in a cold bottoms line 70.

In an embodiment, the cold separated vapor stream in line 68 may be contacted with the hydroisomerized liquid stream in line 152 in an absorber 77. Optionally, an off-gas stream in line 69 may be taken from the cold separated vapor stream in line 68. A remaining recycle vapor stream may be taken in line 72 from the cold separated vapor stream in line 68 and passed to the absorber 77. In an aspect, the recycle vapor stream in line 72 may be compressed in a compressor 73 to provide a compressed recycle vapor stream in line 74 which is passed to the absorber 77. In an exemplary embodiment, a quench stream may be taken in line 76 from the compressed recycle vapor stream in line 74 and passed to the hydrotreating reactor 28. The remaining compressed recycle vapor stream from line 74 is taken in line 75 and passed to the absorber 77.

In an aspect, the hydroisomerized liquid stream in line 152 may be pumped using a pump 37 and the pumped hydroisomerized liquid stream is passed to the absorber in a pumped line 159. In the absorber 77, the remaining compressed recycle vapor stream in line 75 is contacted with the pumped hydroisomerized liquid stream in line 159 to provide a contacted hydroisomerized stream in line 79 and a hydrogen rich gas steam in line 78. The hydrogen rich gas steam in line 78 may be taken from an overhead of the absorber 77 and recycled to the hydrotreating reactor 28 in the hydrotreating hydrogen line 78. A pressure indicating controller (PIC) 47 and a control valve 83 are provided on the hydrotreating hydrogen line 78 to regulate its flow to the hydrotreating reactor 28 based on a pressure setting.

The absorber 77 may be operated at a temperature of about 34° C. (93° F.) to about 60° C. (140° F.) and a pressure essentially the same as or lower than the cold separator 62. In an exemplary embodiment, the absorber 77 is a sponge absorber.

The cold separated liquid stream in line 70 from the bottoms of the cold separator 62. The cold separated liquid stream in line 70 comprises the heavier components including the C16 hydrocarbons which are separated from the hot separated vapor stream in line 38. In an embodiment, the cold separated liquid stream in line 70 is recycled to the EHS 36 perhaps using a pump 39. The cold separated liquid stream in line 70 is passed to the EHS 36 through a second inlet 113 of the EHS located below the first inlet 13 for hydrotreated stream in line 19. By recycling the cold separated liquid stream in line 70 to the EHS 36, the C16 hydrocarbons in the cold separated liquid stream in line 70 are separated into the hot separated liquid stream in line 40. On the other hand, C15-hydrocarbons are separated and remain present in the hot separated vapor stream in line 38. The C15-hydrocarbons are separated in the cold separator 62 and taken in the cold separated vapor stream in line 68.

Liquid hydroisomerized fuel components in the hydroisomerized liquid stream in line 152 exit the absorber 77 in the contacted hydroisomerized stream in the bottoms line 79. The contacted hydroisomerized stream in line 79 comprises diesel and jet boiling range fuels as well as other hydrocarbons such as propane and naphtha.

In an embodiment, the contacted hydroisomerized stream in line 79 may be stripped in an isomerization stripping column 100 to remove hydrogen sulfide and other gases. The contacted hydroisomerized stream in line 79 may be heated by heat exchange with the combined effluent stream in line 163 in the heat exchanger 57 and a heated contacted hydroisomerized stream in line 81 is fed to the isomerization stripping column 100.

A stripping media which is an inert gas such as steam from a stripping media line 104 may be used to strip light gases from the contacted hydroisomerized stream. The isomerization stripping column 100 provides an overhead stripping stream of naphtha, LPG, hydrogen, steam and other gases in a stripper overhead line 87 and a stripped stream in a stripped bottoms line 106. The overhead stripping stream in the overhead line 87 may be condensed by cooling and separated in a stripping receiver 95. A stripper overhead line 88 from the receiver 95 may carry a stripper overhead stream to an off-gas scrubber 140. Unstabilized liquid naphtha from the bottoms of the receiver 95 may be split to provide a reflux stream in line 97 to the isomerization stripping column 100 and a stripper liquid overhead stream that may be transported in line 96 to a debutanizer column 170 for naphtha and LPG recovery. A sour water stream may be collected from a boot of the overhead receiver 95.

The stripping column 100 may be operated with an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 95 ranges from about 38° C. (100° F.) to about 66° C. (150° F.) and the pressure is essentially the same as in the overhead of the isomerization stripping column 100.

A stripped hydroisomerized stream comprising a liquid stream in the stripper bottoms line 106 may be fed to the product fractionation column 120. A diesel stream in the fractionation bottoms line 123 may be taken from a bottom of the product fractionation column 120. A fractionation column bottoms stream in the fractionation bottoms line 123 may comprise diesel boiling range hydrocarbons. A recycle diesel stream 124 may be taken from the fractionation bottoms line 123 for charge to the hydrocracking reactor 161. The product fractionation column 120 may be reboiled by heat exchange with a suitable hot stream or in a fired heater 121 to provide the necessary heat for the distillation. Alternately, a stripping media which is an inert gas such as steam from a stripping media line may be used to heat the column. A reboil stream may be taken in line 128 from the bottoms line 123 and passed to the fired heater 121 and returned boiling to the product fractionation column 120 in a reboil line 141. A diesel product stream may be taken in a diesel product line 129 from the fractionation bottoms line 123 to a diesel pool and may be green diesel. The diesel stream in the distillation bottoms line 123 may be a diesel stream having a T5 of about 230° C. (446° F.) to about 296° C. (590° F.) and a T90 of about 343° C. (650° F.) to about 399° C. (750° F.).

The product fractionation column 120 provides an overhead gaseous stream of naphtha in an overhead line 122. The fractionation overhead stream in line 122 may be completely condensed in a fractionator condenser 125 and separated from water in a fractionation receiver 130. In an embodiment, an air cooler may be employed as the fractionator condenser 125 to condense the overhead gaseous stream of naphtha in line 122. A condensed liquid stream is taken in line 131 from the bottom of the receiver. A reflux stream in line 133 is taken from the condensed liquid stream and refluxed to the product fractionation column 120. Unstabilized liquid naphtha stream is taken from the condensed liquid stream in a fractionator overhead liquid line 132. The unstabilized liquid naphtha stream in line 132 may be combined with a naphtha stream in line 176. A water stream may be collected from a boot of the distillation receiver 130.

A kerosene stream may be taken from the side of the product fractionation column 120 in a side line 134. The kerosene stream taken in the side line 134 may be stripped in a kerosene stripper column 136 to drive off lower boiling materials which are returned back to the product fractionation column 120 at a higher elevation in an overhead kerosene line 135. A stripped bottoms kerosene stream is produced in a bottoms kerosene line 137, from which a boil up stream in line 139 is reboiled and fed back to the kerosene stripper column 136 and a jet fuel product stream is taken in line 138. The jet fuel product stream in line 138 meets jet fuel specifications per ASTM D86 including the freeze point and may be a green jet fuel stream taken from a bottom of the kerosene stripper column 136. The jet fuel stream in line 138 may have no more than 0.1 wt % nC16 hydrocarbons and preferably no nC16 hydrocarbons are present in the jet fuel stream in line 138. Preferably, the concentration of nC16 hydrocarbons is less than detectable. The jet fuel product stream in line 138 may be cooled and transported to the jet fuel pool in line 147, perhaps after giving up a jet fuel product stream in line 148.

The cut point in the product fractionation column 120 between the diesel stream in the bottom line 123 and the jet fuel stream in the side line 134 can be adjusted to ensure that the jet fuel stream has the appropriate composition to meet jet fuel specifications.

A second side stream may be taken in a second side line 185 from the product fractionation column 120. The second side stream in line 185 may be passed to a steam generator 187 to generate steam from a boiler feed water stream in line 186. Steam is taken in line 189 from the steam generator 187. After releasing heat in the steam generator 187, the second side stream is taken in line 188 and fed back to the product fractionation column 120 at a higher location.

The product fractionation column 120 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 130 ranges from about 38° C. (100° F.) to about 66° C. (150° F.) and the pressure is essentially the same as in the overhead of the product fractionation column 120.

In an embodiment, a blend stream of the jet fuel product stream may be taken in line 148 and combined with the diesel product stream in line 129 to provide a hydrotreated vegetable oil (HVO) stream in line 149.

The overhead stripping stream of naphtha, LPG, hydrogen, hydrogen sulfide, steam and other gases in the stripper overhead line 88 may be passed through a trayed or packed off-gas scrubbing column 140 where it is scrubbed by means of a scrubbing liquid such as an aqueous solution fed by scrubbing liquid line 142 to remove acid gases including hydrogen sulfide and carbon dioxide by extracting them into the aqueous solution. Preferred scrubbing liquids include Selexol™ available from UOP LLC in Des Plaines, Illinois and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the overhead stripping stream and absorbs acid gas contaminants such as hydrogen sulfide and carbon dioxide. The resultant “sweetened” overhead stripping stream is taken out from an overhead outlet of the off-gas scrubbing column 140 in a recycle scrubber overhead line 144, and an acid gas rich scrubbing liquid is taken out from the bottoms at a bottom outlet of the recycle scrubber column 140 in a recycle scrubber bottoms line 146. The spent scrubbing liquid from the bottoms may be regenerated and recycled back to the off-gas scrubbing column 140 in the scrubbing liquid line 142. The scrubbed hydrocarbon-rich stream emerges from the off-gas scrubbing column 140 via the off-gas scrubber overhead line 144 and may be forwarded to the sponge absorber column 160 for hydrocarbon recovery.

The off-gas scrubbing column 140 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the off-gas scrubbing column 140 may be operated at a temperature of about 40° C. (104° F.) to about 125° C. (257° F.) and a pressure of about 1200 to about 1600 kPa. The temperature of the overhead stripping stream 88 to the off-gas scrubbing column 140 may be between about 20° C. (68° F.) and about 80° C. (176° F.) and the temperature of the scrubbing liquid stream in the scrubbing liquid line 142 may be between about 20° C. (68° F.) and about 70° C. (158° F.).

The sponge absorber column 160 may receive the scrubbed hydrocarbon-rich stream in the off-gas scrubber overhead line 144. A lean absorbent stream in a lean absorbent line 162 may be fed into the sponge absorber column 160 through an absorbent inlet. The lean absorbent may comprise a naphtha stream in a lean absorbent line 162 perhaps from the debutanizer bottoms stream in line 176. In the sponge absorber column 160, the lean absorbent stream and the scrubbed hydrocarbon-rich stream are counter-currently contacted. The sponge absorbent absorbs LPG hydrocarbons from the net stripper gaseous stream into an absorbent rich stream.

The hydrocarbons absorbed by the sponge absorbent include some methane and ethane and most of the LPG, C₃ and C₄ hydrocarbons, and any C₅ and C₆₊ light naphtha hydrocarbons in the net stripper gaseous stream. The sponge absorber column 160 operates at a temperature of about 34° C. (93° F.) to about 60° C. (140° F.) and a pressure essentially the same as or lower than the off-gas scrubbing column 140 less frictional losses. A sponge absorption off gas stream depleted of LPG hydrocarbons is withdrawn from a top of the sponge absorber column 160 at an overhead outlet through a sponge absorber overhead line 164. The sponge absorption off gas stream in the sponge absorber overhead line 164 may be transported to a fuel gas header that is not shown for providing fuel gas needs. A rich absorbent stream rich in LPG hydrocarbons is withdrawn in a rich absorber bottoms line 166 from a bottom of the sponge absorber column 160 at a bottoms outlet which may be fed to the debutanizer column 170 via the stripper overhead liquid stream in the stripper receiver bottoms line 96.

In an embodiment, the debutanizer column 170 may fractionate the stripper liquid overhead stream and the rich absorbent stream in a debutanizer feed line 167 into a debutanized bottoms stream comprising predominantly C₅₊ hydrocarbons and a debutanizer overhead stream comprising LPG hydrocarbons. The debutanizer overhead stream in a debutanizer overhead line 172 may be fully condensed in the debutanizer receiver 171 with reflux to the debutanizer column 170 and recovery of LPG in a debutanized overhead liquid stream in a debutanizer net receiver bottoms line 174. The debutanized overhead liquid stream in the net receiver bottoms line 174 may be taken as a LPG product stream. In an exemplary embodiment, the debutanizer net receiver bottoms line 174 may be passed to an amine and caustic treatment unit 183 to provide a LPG product stream in line 184.

The debutanized bottoms stream may be withdrawn from a bottom of the debutanizer column 170 in a debutanized bottoms line 175. A reboil stream taken from a debutanized bottoms stream in a debutanizer bottoms line 177 from a bottom of the debutanizer column 170 may be boiled up in the reboil line and sent back to the debutanizer column 170 to provide heat to the column. Alternatively, a hot inert media stream such as steam may be fed to the column 170 to provide heat. A net debutanized bottoms stream in line 176 comprising naphtha may be split between the lean absorbent stream in the lean absorbent line 165 and a product naphtha stream which is cooled and forwarded to a gasoline pool in line 179. In an aspect, the fractionator overhead liquid line 132 may be combined with the naphtha stream in the net debutanized bottoms stream in line 176 to provide a net bottoms naphtha stream in line 178. The net bottoms naphtha stream in line 178 may be split to provide the lean absorbent line 162 and a product naphtha stream in line 179.

Referring back to the product fractionation column 120, a recycle diesel stream in line 124 may be taken from the diesel stream in the bottoms line 123. The recycle diesel stream in line 124 may be hydrocracked and separated in the EHS 36. The recycle diesel stream in line 124 may be fed to a surge drum 111 and taken in a bottoms line 112 of the surge drum 111. The recycle diesel stream is pumped using a pump 45 and taken in a pumped line 114. A cracking make-up gas stream in line 118 may be taken from the compressed make-up gas header 117 and combined with the recycle diesel stream in line 114 to provide a mixed diesel stream in line 116. The mixed diesel stream in line 116 is heat exchanged with a cracked effluent stream in line 168 and a heated mixed diesel stream in line 158 is passed to the cracking reactor 161 to produce the cracked effluent stream in line 168.

In an exemplary embodiment, the cracking reactor 161 is a hydrocracking reactor comprising one or more beds of a hydrocracking catalyst. In the hydrocracking reactor 161, the mixed diesel stream in line 116 is hydrocracked in the presence of a hydrocracking catalyst to produce a hydrocracked effluent stream in line 161. The hydrocracking conditions in the hydrocracking reactor 161 may include a temperature from about 290° C. (550° F.) to about 468° C. (875° F.), preferably 300° C. (572° F.) to about 445° C. (833° F.), a pressure from about 2.7 MPa (gauge) (400 psig) to about 20.7 MPa (gauge) (3000 psig), and a LHSV from about 0.4 to less than about 20 hr⁻¹.

The hydrocracking catalyst may utilize amorphous silica-alumina bases or zeolite bases combined with one or more Group VIII or Group VIB metal hydrogenating components to selectively produce a balance of light diesel and jet fuel distillate. In another aspect, a catalyst which comprises, in general, any crystalline zeolite cracking base upon which is deposited a Group VIII metal hydrogenating component may be suitable. Additional hydrogenating components may be selected from Group VIB for incorporation with the zeolite base.

The zeolite cracking bases are sometimes referred to in the art as molecular sieves and are usually composed of silica, alumina and one or more exchangeable cations such as sodium, magnesium, calcium, rare earth metals, etc. They are further characterized by crystal pores of relatively uniform diameter between about 4 and about 14 Angstroms. It is preferred to employ zeolites having a relatively high silica/alumina mole ratio between about 3 and about 12. Suitable zeolites found in nature include, for example, mordenite, stilbite, heulandite, ferrierite, dachiardite, chabazite, erionite and faujasite. Suitable synthetic zeolites include, for example, the B, X, Y and L crystal types, e.g., synthetic faujasite and mordenite. The preferred zeolites are those having crystal pore diameters between about 8 and 12 Angstroms, wherein the silica/alumina mole ratio is about 4 to 6. One example of a zeolite falling in the preferred group is synthetic Y molecular sieve.

The natural occurring zeolites are normally found in a sodium form, an alkaline earth metal form, or mixed forms. The synthetic zeolites are nearly always prepared in the sodium form. In any case, for use as a cracking base it is preferred that most or all of the original zeolitic monovalent metals be ion-exchanged with a polyvalent metal and/or with an ammonium salt followed by heating to decompose the ammonium ions associated with the zeolite, leaving in their place hydrogen ions and/or exchange sites which have actually been decationized by further removal of water. Hydrogen or “decationized” Y zeolites of this nature are more particularly described in U.S. Pat. No. 3,100,006.

Mixed polyvalent metal-hydrogen zeolites may be prepared by ion-exchanging with an ammonium salt, then partially back exchanging with a polyvalent metal salt and then calcining. In some cases, as in the case of synthetic mordenite, the hydrogen forms can be prepared by direct acid treatment of the alkali metal zeolites. In one aspect, the preferred cracking bases are those which are at least about 10 wt %, and preferably at least about 20 wt %, metal-cation-deficient, based on the initial ion-exchange capacity. In another aspect, a desirable and stable class of zeolites is one wherein at least about 20 wt % of the ion exchange capacity is satisfied by hydrogen ions.

The active metals employed in the preferred hydrocracking catalysts of the present disclosure as hydrogenation components are those of Group VIII, i.e., iron, cobalt, nickel, ruthenium, rhodium, palladium, osmium, iridium and platinum. In addition to these metals, other promoters may also be employed in conjunction therewith, including the metals of Group VIB, e.g., molybdenum and tungsten. The amount of hydrogenating metal in the catalyst can vary within wide ranges. Broadly speaking, any amount between about 0.05 wt % and about 30 wt % may be used. In the case of the noble metals, it is normally preferred to use about 0.05 to about 2 wt % noble metal. Noble metals may be preferred as the hydrogenation metal on the hydrocracking catalyst to provide selectivity to jet fuel due to the absence of hydrogen sulfide and ammonia which can deactivate noble metal catalysts, but which have been removed upstream in the process.

The method for incorporating the hydrogenation metal is to contact the base material with an aqueous solution of a suitable compound of the desired metal wherein the metal is present in a cationic form. Following addition of the selected hydrogenation metal or metals, the resulting catalyst powder is then filtered, dried, pelleted with added lubricants, binders or the like if desired, and calcined in air at temperatures of, e.g., about 371° C. (700° F.) to about 648° C. (1200° F.) in order to activate the catalyst and decompose ammonium ions. Alternatively, the base component may be pelleted, followed by the addition of the hydrogenation component and activation by calcining.

The foregoing catalysts may be employed in undiluted form, or the powdered catalyst may be mixed and copelleted with other relatively less active catalysts, diluents or binders such as alumina, silica gel, silica-alumina cogels, activated clays and the like in proportions ranging between about 5 and about 90 wt %. These diluents may be employed as such, or they may contain a minor proportion of an added hydrogenating metal such as a Group VIB and/or Group VIII metal. Additional metal promoted hydrocracking catalysts may also be utilized in the process of the present disclosure which comprises, for example, aluminophosphate molecular sieves, crystalline chromosilicates and other crystalline silicates. Crystalline chromosilicates are more fully described in U.S. Pat. No. 4,363,178.

DI-100 available from UOP LLC in Des Plaines, Illinois may be a suitable hydrocracking catalyst.

A hydrocracked effluent stream is taken in line 168 from the bottoms of the hydrocracking reactor 161. The hydrocracked effluent stream in line 168 is heat exchanged with the mixed diesel stream in line 116 to provide a cooled hydrocracked effluent stream in line 169. The cooled hydrocracked effluent stream in line 169 is combined with the hydroisomerized stream in line 50 to provide the combined effluent stream in line 163 and processed as previously described.

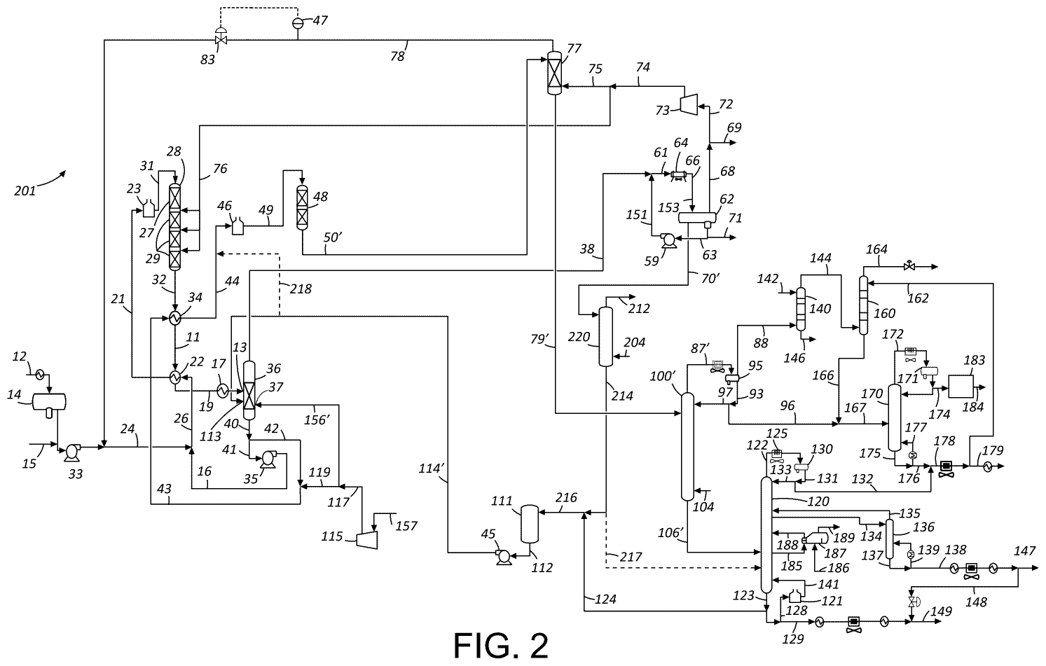

Another exemplary embodiment of the process for producing biofuel from biorenewable feedstock is shown in FIG. 2. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The process 201 as shown in FIG. 2 comprises a second stripping column 220 for stripping the cold separated liquid stream. The configuration and operation of the embodiment of FIG. 2 is essentially the same as in FIG. 1 with the following exceptions.

In the embodiment shown in FIG. 2, the stripping hydrogen stream in line 156′ is taken from the make-up gas header 117 and passed to the EHS 36′. A hot separated liquid stream is taken in line 40′ from the bottoms of the EHS 36.

A hydroisomerized stream is taken in a hydroisomerized line 50′ from the hydroisomerization reactor 48. In the embodiment as shown in FIG. 2, the hydroisomerized stream in line 50′ is contacted in the absorber 77 with the compressed recycle vapor stream in line 75 to provide a contacted hydroisomerized stream in line 79′. Further, the cold separated liquid stream is taken in line 70′ from the cold separator 62. The contacted hydroisomerized stream in line 79′ is passed to the isomerization stripping column 100′. The cold separated liquid stream in line 70′ is passed to the cold stripping column 220.

In an exemplary embodiment, the contacted hydroisomerized stream in line 79′ is fed to the isomerization stripping column 100′. A stripping media which is an inert gas such as steam from a stripping media line 104 may be used to strip light gases from the contacted hydroisomerized stream in line 79′ in the stripping column 100′. The stripping column 100′ may be operated with an overhead pressure of about 0.35 MPa (gauge) (50 psig), preferably no less than about 0.70 MPa (gauge) (100 psig), to no more than about 2.0 MPa (gauge) (290 psig). An overhead stripping stream comprising naphtha, LPG, hydrogen, steam and other gases is taken in an overhead line 87′ from the second stripping column 220. The overhead stripping stream of naphtha, LPG, hydrogen, steam and other gases in the stripper overhead line 87′ is processed as previously described in FIG. 1.

A stripped stream in a stripped bottoms line 106′ is taken from the bottoms of the stripping column 100′ and fed to the product fractionation column 120. In an embodiment, the recycle diesel stream in line 124 may be directly recycled to the EHS 36. As shown, the recycle diesel stream in line 124 may be fed to the surge drum 111.

In the embodiment as shown in FIG. 2, the cold separated liquid stream in line 70′ is passed to the cold stripping column 220. In the cold stripping column 220, the cold separated liquid stream in line 70′ is stripped of light gases. A stripping media such as steam in line 204 is passed to the cold stripping column 220 to strip the light gases. An overhead stripping stream of light gases is taken in line 212 from the overhead of the second stripping column 220. A stripped bottoms stream comprising fuel components in line 214 is taken from the bottoms of the second stripping column 220. The overhead light gas stream in line 212 may be passed to the off-gas scrubber 140.

Optionally, a portion of the bottoms stream in line 217 may be taken from the bottoms stream of the second stripping column 220. The portion of the bottoms stream in line 217 is fractionated in the product fractionation column 120 with the stripped stream in the stripped bottoms line 106′. The portion of the bottoms stream in line 217 may be passed to a location below the stripped stream in the stripped bottoms line 106′ in the product fractionation column 120.

In an exemplary embodiment, the stripped bottoms stream in line 214 is combined with the recycle diesel stream in line 124 to provide a combined recycle diesel stream in line 216. The combined recycle diesel stream in line 216 may be fed to the surge drum 111 and taken in a bottoms line 112 of the surge drum 111. The combined recycle diesel stream is pumped using the pump 45 and taken in a pumped line 114′. The combined recycle diesel stream in line 114′ is charged to the EHS 36. In the embodiment as shown in FIG. 2, the combined recycle diesel stream in line 114′ is charged to the EHS 36 through the second inlet 113 of the EHS located below the first inlet 13 for the hydrotreated stream in line 19. The rest of the process is same as previously described in FIG. 1.

Optionally, a portion of the combined recycle diesel stream in line 114′ may be taken in line 218 and charged to the hydroisomerization reactor 48 such as with the heated combined hydroisomerization charge stream in line 44.

Although the embodiment as shown in FIG. 2 includes two sperate stripping columns 100′ and 220, it is within the scope of the present disclosure that the stripping columns 100′ and 220 may be included in a single vessel such as in a stacked configuration.

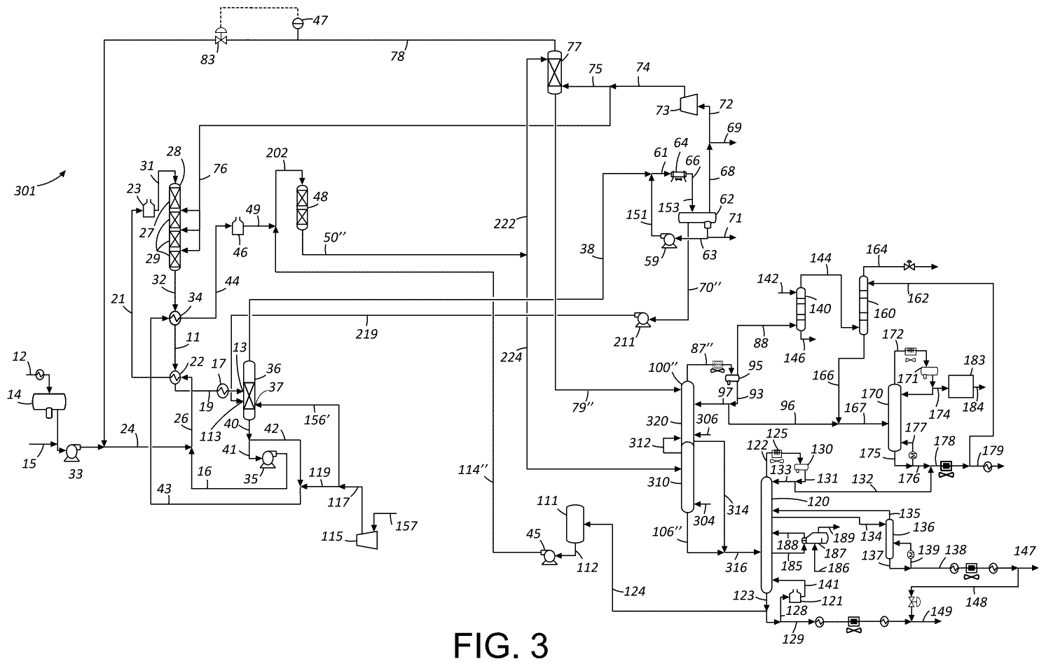

Yet another exemplary embodiment of the process for producing biofuel from biorenewable feedstock is shown in FIG. 3. Elements in FIG. 3 with the same configuration as in FIG. 2 will have the same reference numeral as in FIG. 1. Elements in FIG. 3 which have a different configuration as the corresponding element in FIG. 2 will have the same reference numeral but designated with a double prime symbol (″). The process 301 as shown in FIG. 3 comprises a dual stripping column 100″. The recycle diesel stream in line 114″ is charged to the hydroisomerization reactor 48. The configuration and operation of the embodiment of FIG. 3 is essentially the same as in FIG. 1 with the following exceptions.

In the embodiment as shown in FIG. 3, the combined hydroisomerization charge stream in the heated hydroisomerization charge line 49 is combined with the recycle diesel stream in line 114″. A twice combined hydroisomerization charge stream is taken in line 202 and charged to the hydroisomerization reactor 48. A hydroisomerized stream is taken in line 50″ from the hydroisomerization reactor 48. The hydroisomerized stream in line 50″ is split to provide a first hydroisomerized stream in line 222 and a second hydroisomerized stream in line 224. The first hydroisomerized stream in line 222 is contacted in the absorber 77 with the compressed recycle vapor stream in line 75 to provide a contacted hydroisomerized stream in line 79″. From the cold separator 62, the cold separated liquid stream in line 70″ is fed to the EHS 36 perhaps using a pump 211 and in a pumped line 219. In the embodiment as shown in FIG. 3, the cold separated liquid stream in line 70″ is charged to the EHS 36 through the second inlet 113 of the EHS located below the first inlet 13 for the hydrotreated stream in line 19.

In the embodiment as shown in FIG. 3, the contacted hydroisomerized stream in line 79″ and the second hydroisomerized stream in line 224 are stripped in the dual stripping column 100″. The dual stripping column 100″ comprises an upper stripping column 320 and a lower stripping column 310. In an exemplary embodiment, the second hydroisomerized stream in line 224 is fed to the lower stripping column 310. A stripping media which is an inert gas such as steam from a stripping media line 304 may be used to strip light gases from the second hydroisomerized stream in line 224 in the lower stripping column 310. The lower stripping column 310 may be operated with an overhead pressure of about 0.35 MPa (gauge) (50 psig), preferably no less than about 0.70 MPa (gauge) (100 psig), to no more than about 2.0 MPa (gauge) (290 psig). An overhead stripping stream is taken in an overhead line 312 of the lower stripping column 310 and fed to the upper stripping column 320 near bottoms.

In another exemplary embodiment, the contacted hydroisomerized stream in line 79″ is fed to the upper stripping column 320. The contacted hydroisomerized stream in line 79″ and the overhead stripping stream in line 312 of the lower stripping column 310 are stripped of the light gases in the upper stripping column 320. The upper stripping column 320 may be operated with an overhead pressure of about 0.35 MPa (gauge) (50 psig), preferably no less than about 0.70 MPa (gauge) (100 psig), to no more than about 2.0 MPa (gauge) (290 psig). A stripping media which is an inert gas such as steam from a stripping media line 306 may be used to strip light gases from the contacted hydroisomerized stream in line 79″ and the overhead stripping stream in line 312 of the lower stripping column 310. An overhead stripping stream comprising naphtha, LPG, hydrogen, steam and other gases is taken in an overhead line 87″ from the upper stripping column 320. The overhead stripping stream of naphtha, LPG, hydrogen, steam and other gases in the stripper overhead line 87″ is processed as previously described in FIG. 1.

A stripped stream in a stripped bottoms line 106″ is taken from the bottoms of the lower stripping column 310 and fractionated in the product fractionation column 120. An upper bottoms stream may be taken in upper bottoms line 314 from the upper stripping column 320. In an embodiment, the upper bottoms stream in line 314 may be combined with the stripped stream in bottoms line 106″ to provide a combined stripped stream in line 316 and fed to the product fractionation column 120.

The recycle diesel stream in line 124 from the product fractionation column 120 may be fed to the surge drum 111 and taken in a bottoms line 112 of the surge drum 111. The recycle diesel stream is pumped using a pump 45, and taken in a pumped line 114″. The recycle diesel stream in line 114″ is charged to the hydroisomerization reactor 48 and processes as earlier described. The rest of the process is same as previously described in FIG. 1.

### EXAMPLE

A simulation study was conducted. The process was compared with a base process. The base process did not include the sponge absorber. In the exemplary process, the recycle vapor stream in line 72 was contacted in the sponge absorber 77. The exemplary process did not include a recycle gas scrubber which was present in the base process. Results of the study are shown in the table as below:

TABLE

| | Base case | |
|---|---|---|
| | No Sponge | Sponge Absorber with no |
| | Absorber | Recycle Gas Scrubber |
| nC16 in SAF Product | 2.18 | 0 |
| Recycle Gas Purity | 82.85 | 72 |
| SAF Yield, wt % | Base | Base + 0.7 |

As evident from the results, the process with the sponge absorber produced zero nC16 in the SAF. Also, the process with the sponge absorber had an improved yield over the base process, increasing yield of SAF by 0.7 wt %.

### Specific Embodiments

While the following is described in conjunction with specific embodiments, it will be understood that this description is intended to illustrate and not limit the scope of the preceding description and the appended claims.

A first embodiment of the present disclosure is a process for producing biofuel from biorenewable feedstock, the process comprising hydrotreating a biorenewable feed stream in a hydrotreating reactor to produce a hydrotreated stream; separating the hydrotreated stream in a hot separator into a hot separated vapor stream and a hot separated liquid stream; hydroisomerizing a hydroisomerization feed stream taken from the hot separated liquid stream in a hydroisomerization reactor in the presence of hydrogen over a hydroisomerization catalyst to provide a hydroisomerized stream; and contacting the hydroisomerized stream with a recycle vapor stream taken from the hot separated vapor stream to provide a contacted hydroisomerized stream. An embodiment of the present disclosure is one, any or all of prior embodiments in this paragraph up through the first embodiment in this paragraph further comprising separating the hydroisomerized stream to provide a hydroisomerized vapor stream and a hydroisomerized liquid stream; and contacting the hydroisomerized liquid stream with the recycle vapor stream to provide the contacted hydroisomerized liquid stream. An embodiment of the present disclosure is one, any or all of prior embodiments in this paragraph up through the first embodiment in this paragraph further comprising separating the hot separated vapor stream in a cold separator to provide a cold separated vapor stream and a cold separated liquid stream; and taking the recycle vapor stream from the cold separated vapor stream. An embodiment of the present disclosure is one, any or all of prior embodiments in this paragraph up through the first embodiment in this paragraph further comprising compressing the recycle vapor stream to produce a compressed recycle vapor stream; and contacting the hydroisomerized stream with the compressed recycle vapor stream to provide the contacted hydroisomerized stream and a hydrogen rich vapor steam. An embodiment of the present disclosure is one, any or all of prior embodiments in this paragraph up through the first embodiment in this paragraph, wherein the compressed recycle vapor stream is contacted with the contacted hydroisomerized stream in a sponge absorber. An embodiment of the present disclosure is one, any or all of prior embodiments in this paragraph up through the first embodiment in this paragraph, wherein the hydrogen rich gas steam is recycled to the hydrotreating reactor. An embodiment of the present disclosure is one, any or all of prior embodiments in this paragraph up through the first embodiment in this paragraph further comprising separating the cold separator liquid stream in the hot separator. An embodiment of the present disclosure is one, any or all of prior embodiments in this paragraph up through the first embodiment in this paragraph further comprising stripping the cold separator liquid stream and the hydrotreated stream in the hot separator. An embodiment of the present disclosure is one, any or all of prior embodiments in this paragraph up through the first embodiment in this paragraph further comprising hydroisomerizing the hot separated liquid stream in the hydroisomerization reactor to provide the hydroisomerized stream. An embodiment of the present disclosure is one, any or all of prior embodiments in this paragraph up through the first embodiment in this paragraph further comprising recycling the hydroisomerized vapor stream to the hot separator. An embodiment of the present disclosure is one, any or all of prior embodiments in this paragraph up through the first embodiment in this paragraph further comprising stripping the contacted hydroisomerized stream to provide a stripped stream; and fractionating the stripped stream to produce a fuel stream, and a bottoms liquid stream. An embodiment of the present disclosure is one, any or all of prior embodiments in this paragraph up through the first embodiment in this paragraph further comprising recycling a liquid recycle stream taken from the bottoms liquid stream to the hydroisomerization reactor. An embodiment of the present disclosure is one, any or all of prior embodiments in this paragraph up through the first embodiment in this paragraph further comprising; taking a first hydroisomerized stream from the hydroisomerized stream; and contacting the first hydroisomerized stream with the recycle vapor stream to provide a contacted first hydroisomerized stream. An embodiment of the present disclosure is one, any or all of prior embodiments in this paragraph up through the first embodiment in this paragraph further comprising taking a second hydroisomerized stream from the hydroisomerized stream; and fractionating the second hydroisomerized stream and the contacted first hydroisomerized stream to produce a biofuel stream. An embodiment of the present disclosure is one, any or all of prior embodiments in this paragraph up through the first embodiment in this paragraph further comprising stripping the contacted hydroisomerized stream in an isomerization stripping column to provide a first stripped stream; stripping the cold separated liquid stream in a cold stripping column to provide a second stripped stream; fractionating the first stripped stream; and recycling the second stripped stream to the hot separator.

A second embodiment of the present disclosure is a process for producing biofuel from biorenewable feedstock, the process comprising hydrotreating a biorenewable feed stream in a hydrotreating reactor to produce a hydrotreated stream; separating the hydrotreated stream in a hot separator into a hot separated vapor stream and a hot separated liquid stream; hydroisomerizing a hydroisomerization feed stream taken from the hot separated liquid stream in a hydroisomerization reactor in the presence of hydrogen over a hydroisomerization catalyst to provide a hydroisomerized stream; separating the hot separated vapor stream in a cold separator to provide a cold separated vapor stream and a cold separated liquid stream; and contacting the hydroisomerized stream with a recycle vapor stream taken from the cold separated vapor stream to provide a contacted hydroisomerized stream. An embodiment of the present disclosure is one, any or all of prior embodiments in this paragraph up through the second embodiment in this paragraph further comprising separating the hydroisomerized stream to provide a hydroisomerized vapor stream and a hydroisomerized liquid stream; and contacting the hydroisomerized liquid stream with the recycle vapor stream to provide the contacted hydroisomerized liquid stream. An embodiment of the present disclosure is one, any or all of prior embodiments in this paragraph up through the second embodiment in this paragraph further comprising separating the cold separated liquid stream in the hot separator.

A third embodiment of the present disclosure is a process for producing biofuel from biorenewable feedstock, the process comprising hydrotreating a biorenewable feed stream in a hydrotreating reactor to produce a hydrotreated stream; separating the hydrotreated stream in a hot separator into a hot separated vapor stream and a hot separated liquid stream; hydroisomerizing a hydroisomerization feed stream taken from the hot separated liquid stream in a hydroisomerization reactor in the presence of hydrogen over a hydroisomerization catalyst to provide a hydroisomerized stream; separating the hot separated vapor stream in a cold separator to provide a cold separated vapor stream and a cold separated liquid stream; contacting the hydroisomerized stream in a sponge absorber with a recycle vapor stream taken from the cold separated vapor stream to provide a contacted hydroisomerized stream; and separating the cold separated liquid stream in the hot separator. An embodiment of the present disclosure is one, any or all of prior embodiments in this paragraph up through the third embodiment in this paragraph, wherein the hot separator and the sponge absorber are maintained in a single vessel. An embodiment of the present disclosure is one, any or all of prior embodiments in this paragraph up through the third embodiment in this paragraph, wherein the hot separator is located below the sponge absorber in the vessel.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for producing biofuel from biorenewable feedstock, the process comprising:
hydrotreating a biorenewable feed stream in a hydrotreating reactor to produce a hydrotreated stream;
separating the hydrotreated stream in a hot separator into a hot separated vapor stream and a hot separated liquid stream;
hydroisomerizing a hydroisomerization feed stream taken from said hot separated liquid stream in a hydroisomerization reactor in the presence of hydrogen over a hydroisomerization catalyst to provide a hydroisomerized stream; and
contacting said hydroisomerized stream with a recycle vapor stream taken from said hot separated vapor stream to provide a contacted hydroisomerized stream.

2. The process of claim 1 further comprising:
separating said hydroisomerized stream to provide a hydroisomerized vapor stream and a hydroisomerized liquid stream; and
contacting said hydroisomerized liquid stream with said recycle vapor stream to provide said contacted hydroisomerized liquid stream.

3. The process of claim 1 further comprising:
separating said hot separated vapor stream in a cold separator to provide a cold separated vapor stream and a cold separated liquid stream; and
taking said recycle vapor stream from said cold separated vapor stream.

4. The process of claim 3 further comprising:
compressing said recycle vapor stream to produce a compressed recycle vapor stream; and
contacting said hydroisomerized stream with said compressed recycle vapor stream to provide said contacted hydroisomerized stream and a hydrogen rich gas steam.

5. The process of claim 4, wherein said compressed recycle vapor stream is contacted with said contacted hydroisomerized stream in a sponge absorber.

6. The process of claim 4, wherein said hydrogen rich gas steam is recycled to the hydrotreating reactor.

7. The process of claim 3 further comprising separating said cold separator liquid stream in said hot separator.

8. The process of claim 7 further comprising stripping said cold separator liquid stream and said hydrotreated stream in said hot separator.

9. The process of claim 8 further comprising hydroisomerizing said hot separated liquid stream in the hydroisomerization reactor to provide said hydroisomerized stream.

10. The process of claim 2 further comprising recycling said hydroisomerized vapor stream to the hot separator.

11. The process of claim 9 further comprising:
stripping said contacted hydroisomerized stream to provide a stripped stream; and
fractionating said stripped stream to produce a fuel stream, and a bottoms liquid stream.

12. The process of claim 11 further comprising recycling a liquid recycle stream taken from said bottoms liquid stream to the hydroisomerization reactor.

13. The process of claim 1 further comprising;
taking a first hydroisomerized stream from said hydroisomerized stream; and
contacting said first hydroisomerized stream with said recycle vapor stream to provide a contacted first hydroisomerized stream.

14. The process of claim 10 further comprising:
taking a second hydroisomerized stream from said hydroisomerized stream; and
fractionating said second hydroisomerized stream and said contacted first hydroisomerized stream to produce a biofuel stream.

15. A process for producing biofuel from biorenewable feedstock, the process comprising:
hydrotreating a biorenewable feed stream in a hydrotreating reactor to produce a hydrotreated stream;
separating the hydrotreated stream in a hot separator into a hot separated vapor stream and a hot separated liquid stream;
hydroisomerizing a hydroisomerization feed stream taken from said hot separated liquid stream in a hydroisomerization reactor in the presence of hydrogen over a hydroisomerization catalyst to provide a hydroisomerized stream;
separating said hot separated vapor stream in a cold separator to provide a cold separated vapor stream and a cold separated liquid stream; and
contacting said hydroisomerized stream with a recycle vapor stream taken from said cold separated vapor stream to provide a contacted hydroisomerized stream.

16. The process of claim 15 further comprising:
separating said hydroisomerized stream to provide a hydroisomerized vapor stream and a hydroisomerized liquid stream; and
contacting said hydroisomerized liquid stream with said recycle vapor stream to provide said contacted hydroisomerized liquid stream.

17. The process of claim 15 further comprising separating said cold separated liquid stream in said hot separator.

18. A process for producing biofuel from biorenewable feedstock, the process comprising:
hydrotreating a biorenewable feed stream in a hydrotreating reactor to produce a hydrotreated stream;
separating the hydrotreated stream in a hot separator into a hot separated vapor stream and a hot separated liquid stream;
hydroisomerizing a hydroisomerization feed stream taken from said hot separated liquid stream in a hydroisomerization reactor in the presence of hydrogen over a hydroisomerization catalyst to provide a hydroisomerized stream;
separating said hot separated vapor stream in a cold separator to provide a cold separated vapor stream and a cold separated liquid stream;
contacting said hydroisomerized stream in a sponge absorber with a recycle vapor stream taken from said cold separated vapor stream to provide a contacted hydroisomerized stream; and
separating said cold separated liquid stream in the hot separator.

19. The process of claim 18, wherein the hot separator and the sponge absorber are maintained in a single vessel.

20. The process of claim 19, wherein the hot separator is located below the sponge absorber in the vessel.
